(19) United States
(12) Patent Application Publication
(10) Pub. No.: US 2012/0249488 A1
(43) Pub. Date: Oct. 4, 2012

(54) Stylus structure for touch panel

(76) Inventor: MAO-SUNG WU, Lujhu Township (TW)

(21) Appl. No.: 13/076,692

(22) Filed: Mar. 31, 2011

(51) Int. Cl. G06F 3/033

(52) U.S. Cl. 345/179; 178/19.01

(57) ABSTRACT

A stylus structure for a touch panel includes a hand-held portion and a touch portion. The touch portion is disposed at an end of the hand-held portion. The touch portion has a soft material body and an encapsulation layer for encapsulating the body. A user can hold the hand-held portion to operate a touch panel when the touch portion is in contact with the touch panel (e.g. a capacitive touch panel) to generate the variation of capacitance. Further, the preferred smoothness can be provided by utilizing the encapsulation layer at the end so that the touch panel can be prevented from being damaged when the user performs a sliding touch operation.

### BACKGROUND OF THE INVENTION

1. Field of the Invention

The present invention relates to a stylus screen structure, and more particularly to a stylus structure for touch panel.

2. Description of the Related Art

A present touch technique is widely applied to various electronic products. Generally, the touch technique can be divided into five types of resistive type, capacitive type, surface acoustic wave type, optics type and electromagnetic type according to the induction principle. The resistive touch panel utilizes a pressing manner to allow an upper conductive film being in contact with a lower conductive film, thereby operating the sensitive touch panel. In addition, the capacitive touch panel is slightly touched by a user's fingers to generate the variation of capacitance between fingers and the capacitive touch panel so as to operate the capacitive touch panel. In another word, the sensitivity of operating the capacitive touch panel occupies a significant advantage by comparing with the resistive touch panel.

Moreover, the capacitive touch panel has the additional advantages of being dustproof, flameproof, scratch resistant, high resolution, high transmittance, low reflection, high contrast ratio, greater durability, multi-touch and gesture operation when compared with a normal resistive touch panel so as to become a target aggressively developed by many companies.

With reference to FIG. 1(A), a user operates a capacitive touch panel 91 and uses a finger 92 to operate a virtual keyboard 93 of the capacitive touch panel 91. However, during the operation process, since the finger 92 covers a portion of sight view of the user and the area of the finger 92 is large to easily touch other scopes, unexpected motions occur to cause an error touch. Moreover, the serious situation is that error touch is usually caused by a user with larger fingers.

Further, a fingernail 94 of the finger 92 is not a conductor, and a proper capacitance may not be generated between the fingernail 94 and the capacitive touch panel 91 to operate the capacitive touch panel 91. Therefore, a user with longer fingernails may have difficulty in operating the capacitive touch panel 91.

In addition, a user's fingers of people may become dirty. More specifically, hot weather can cause hand perspiration, which is a serious problem. Consequently, when frequently touching the capacitive touch panel 91 through the finger 92 with hand perspiration, dirt may remain on the surface of the capacitive touch panel 91 resulting in an unclean surface of the capacitive touch panel 91.

Therefore, the technique of using the finger 92 to operate the capacitive touch panel 91 still has many shortcomings to be overcome. A stylus structure is also provided to effectively generate proper capacitance to rapidly and precisely operate the capacitive touch panel 91 under a condition of frequently maintaining the clean of the capacitive touch panel 91. As shown in FIG. 1(B), a U.S. Pat. No. 5,914,708 disclosed the structure. The stylus structure has a hand-held portion 95, which is made of a conductive material, and a touch portion 96. A protective jacket 97 made of a conductive foam is disposed on the touch portion 96. While in use, a hand holds the hand-held portion 95 and uses the touch portion 96 to touch the panel. The hand-held portion 95 made of the conductive material and the touch portion 96 are utilized to generate capacitance coupling together with an electric field provided from the conductive layer at an outside of the panel. Afterward, the human body absorbs minor current to allow the electrode to detect current, thereby performing the touch operation.

Although the stylus structure can utilize the touch portion 96 and the protective jacket 97 made of conductive foam to touch the capacitive touch panel so as to achieve the touch effect of capacitance coupling, the friction coefficient of the protective jacket 97 made of the conductive foam is great while performing hand writing or dragging functions on the touch panel. Consequently, a larger friction between the protective jacket 97 and the capacitive touch panel is formed, resulting in producing worsened smoothness while performing dragging and hand writing functions. The foregoing drawback may violate the advantage capable of imposing slight force on the capacitive touch panel.

### SUMMARY OF THE INVENTION

In view of the shortcomings of the prior art, the inventor(s) of the present invention based on years of experience in the related industry to conduct extensive researches and experiments, and finally developed a stylus structure as a primary objective, and more particularly to a stylus structure for touch panel.

To achieve the foregoing objective, the stylus structure according to the invention comprises a hand-held portion and a touch portion. The touch portion is disposed at an end of the hand-held portion. The touch portion has a soft material body and an encapsulation layer for encapsulating the soft material body.

While in use, a user can hold the hand-held portion to operate the touch panel when the touch portion is in contact with the touch panel (e.g. a capacitive touch panel) to generate the variation of capacitance. The soft material body of the touch portion is utilized to tightly paste the touch panel to prevent the touch panel from being damaged due to an excess pressing force.

### BRIEF DESCRIPTION OF THE DRAWINGS

FIG. 1(A) is a schematic diagram of a status for a conventional capacitive touch panel operated by fingers;

FIG. 1(B) is a schematic diagram of a stylus structure for U.S. Pat. No. 5,914,708;

FIG. 2 is a three-dimensional diagram of a stylus structure according to a first embodiment of the invention;

FIGS. 3(A), (B) are schematic diagrams of a touch portion according to the invention;

FIG. 4 is schematic diagram of a utilization of a stylus structure according to a first embodiment of the invention;

FIG. 5 is a three-dimensional diagram of a stylus structure according to a second embodiment of the invention;

FIG. 6 is a schematic diagram of a utilization of a stylus structure according to a second embodiment of the invention;

FIG. 7 is a schematic diagram of a stylus structure according to a third embodiment of the invention;

FIG. 8 is a schematic diagram of a stylus structure according to a fourth embodiment of the invention; and

FIG. 9 is a schematic diagram of a utilization of a stylus structure according to a fourth embodiment of the invention.

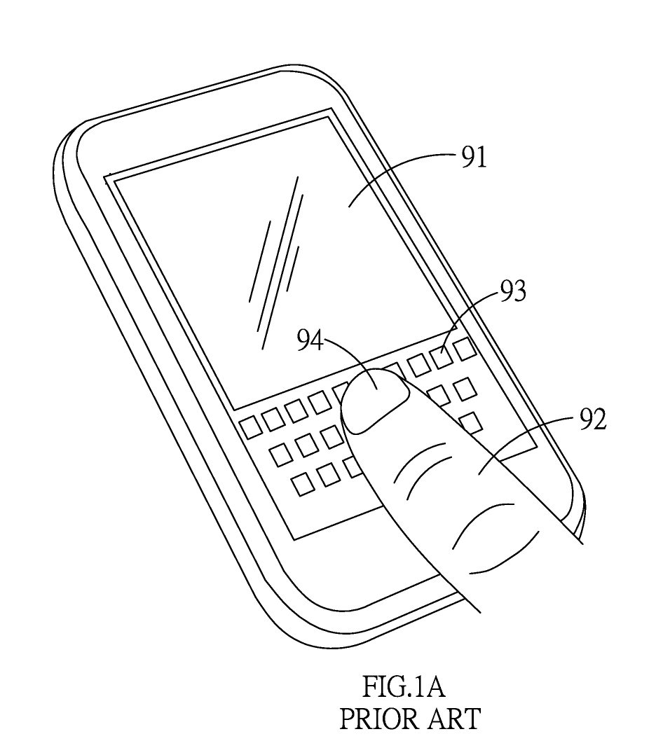

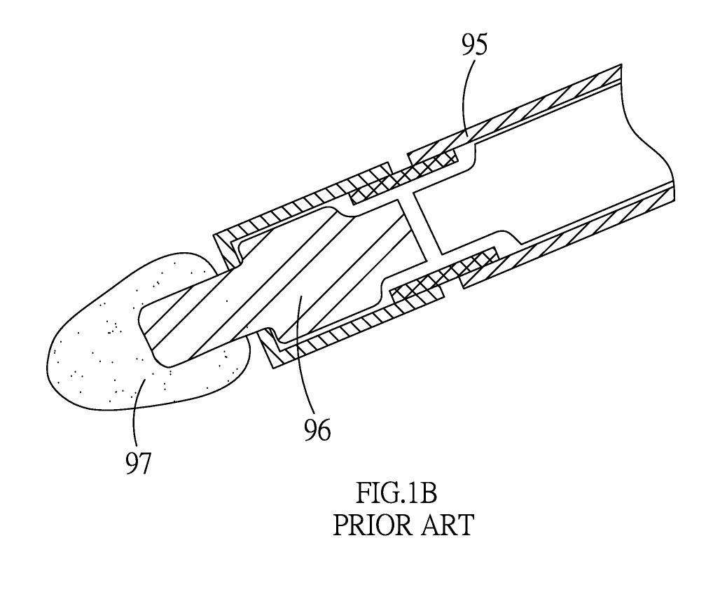

### DETAILED DESCRIPTION OF THE PREFERRED EMBODIMENTS

The foregoing and other technical characteristics of the present invention will become apparent with the detailed description of the preferred embodiments and the illustration of the related drawings.

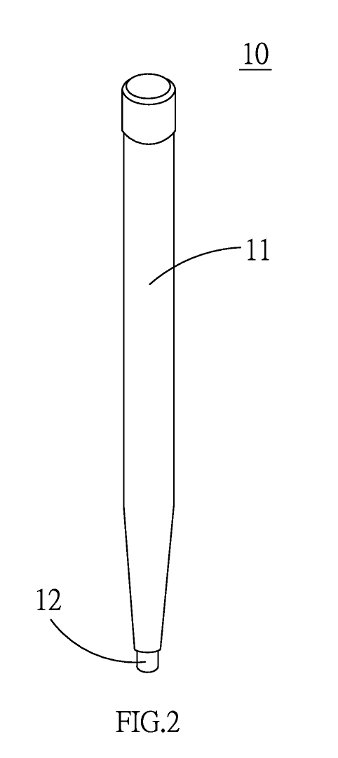

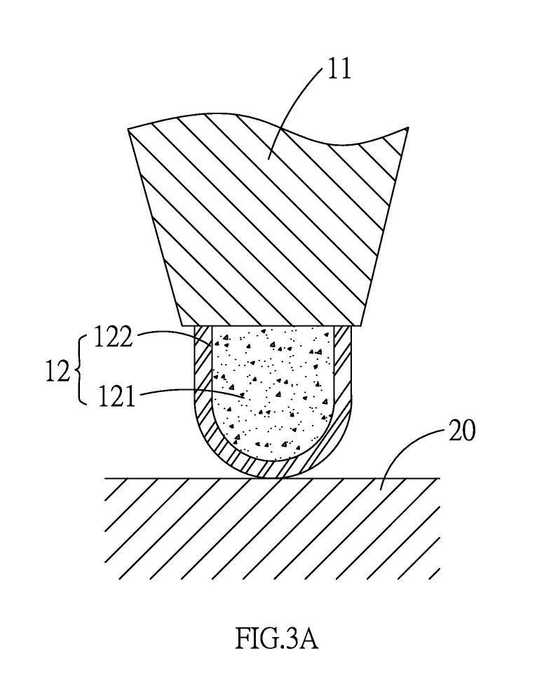

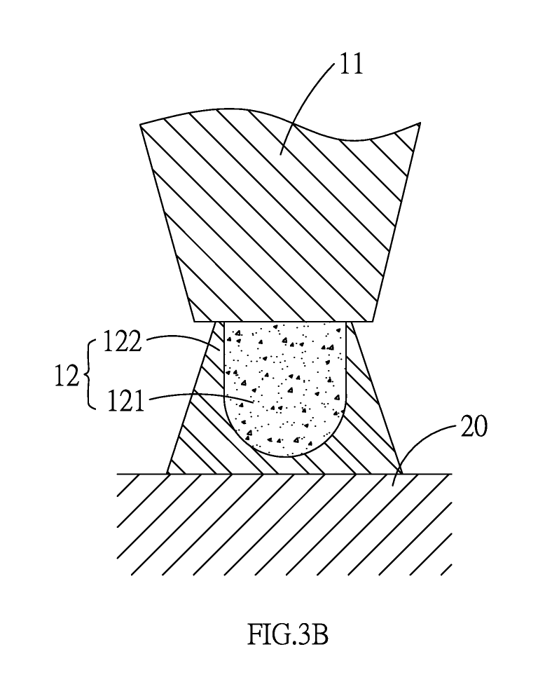

As shown in a first embodiment of FIG. 2, a stylus structure 10 comprises a hand-held portion 11 and a touch portion 12. As shown in the embodiment, the stylus structure 10 can be a pen-like structure. The hand-held portion 11 can be a pen shaft. The touch portion 12 is disposed at an end of the hand-held portion 11. With reference to FIG. 3(A), the touch portion 12 is equipped with a soft material body 121 and an encapsulation layer 122 for encapsulating the body 121. Of course, the encapsulation layer 122 can also form a structural body with a larger bottom area as shown in FIG. 3(B) to increase the touch area.

The body 121 of the touch portion can be rubber, plastic or foam. The encapsulation layer 122 can be a conductive material that is disposed on the body 121 of the touch portion through carbon powder or by means of coating. Alternatively, the encapsulation layer can be made of non-conductive materials such as PU (polyurethane) or silica gel.

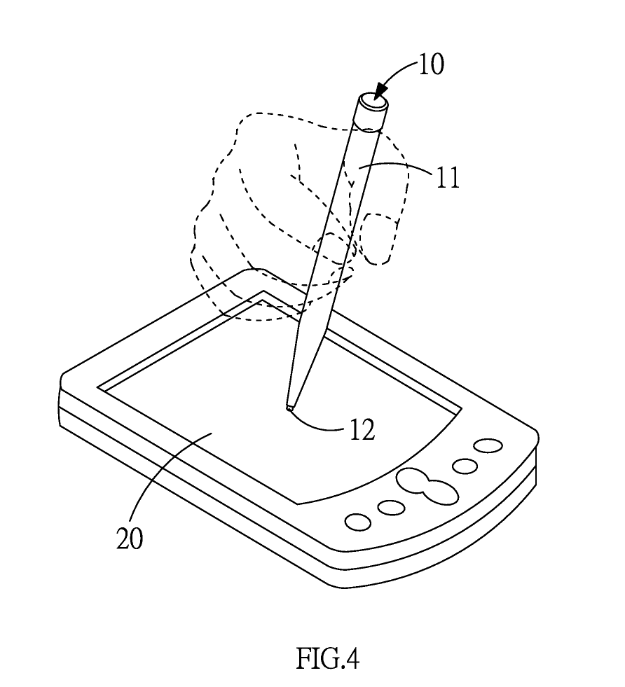

The stylus structure of the invention can be applied to various touch panels, such as a resistive type, capacitive type, surface acoustic wave type, optics type and electromagnetic type touch panels. For example, when applied in a capacitive type touch panel, the hand-held portion can be a conductive material. With reference to FIG. 4, a user can hold the hand-held portion 11. When the touch portion 12 is in contact with the capacitive touch panel 20, the conductivity of the stylus structure 10 is utilized to perform capacitive coupling with the electric field generated by the encapsulation layer of the capacitive touch panel 20, and a human body then absorbs minor current to allow the electrode to detect current so as to operate the capacitive touch panel 20. Further, the body 121 of the touch portion made of the soft material is utilized. When the touch portion 12 presses a glass panel of the capacitive touch panel 20, the glass panel is deformed so that the touched area can be further pasted to the capacitive touch panel 20 to increase the touch area of touch points. It does not only have the touch function originally provided by the stylus structure 10, but also protects the capacitive touch panel 20 from scratching. Alternatively, it can prevent the panel from being damaged due to a high magnitude pressing force, resulting in dirt and marks remaining on the capacitive touch panel 20. Of course, the encapsulation layer can also be a conductive material.

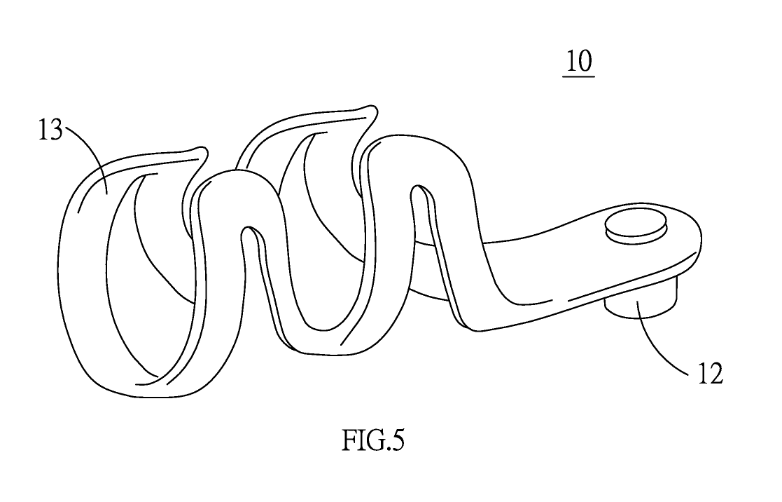

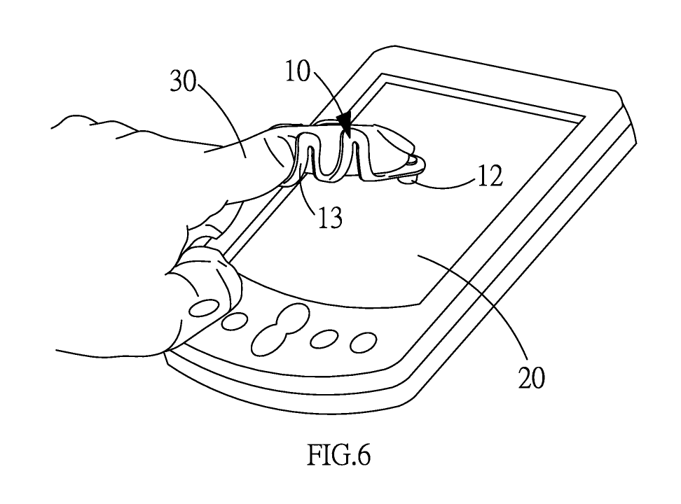

As shown in a second embodiment of FIG. 5 and FIG. 6, the stylus structure 10 can also be a finger ring structure. The hand-held portion can be a flexible collar 13. The user fits the flexible collar 13 on his/her finger 30 to conveniently operate the structure.

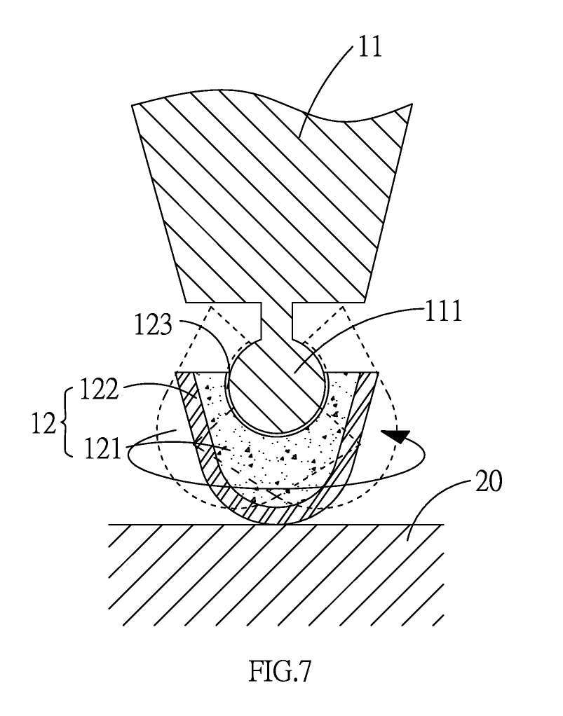

As shown in a third embodiment of FIG. 7, an end of the hand-held portion 11 is further equipped with a pivot member 111. The pivot member 111 is connected to the touch portion 12, wherein the pivot member 111 can be a sphere joint. The touch portion 12 is relatively formed with an arc junction surface 123 so that the touch portion 12 can be full-directionally rotated at the pivot member 111 to regulate various degrees. It may not have a blind spot to restrict the touch portion 12 to allow the user to flexibly control the touch portion 12 at any regulated angle and stably lead the stylus structure 10 so as to be tightly in contact with the capacitive touch panel 20.

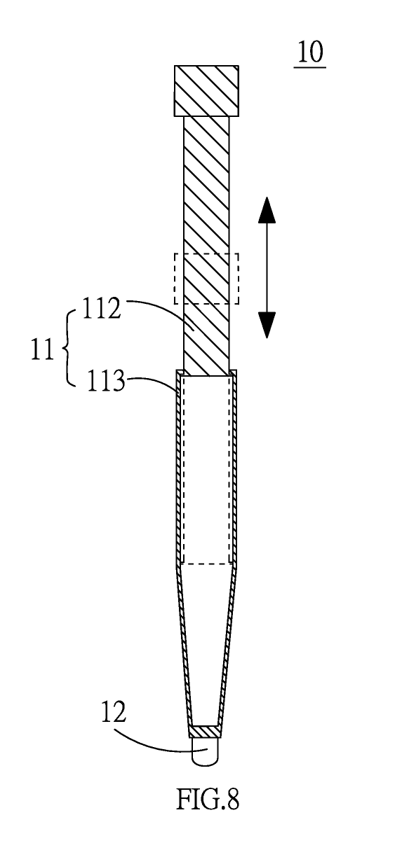

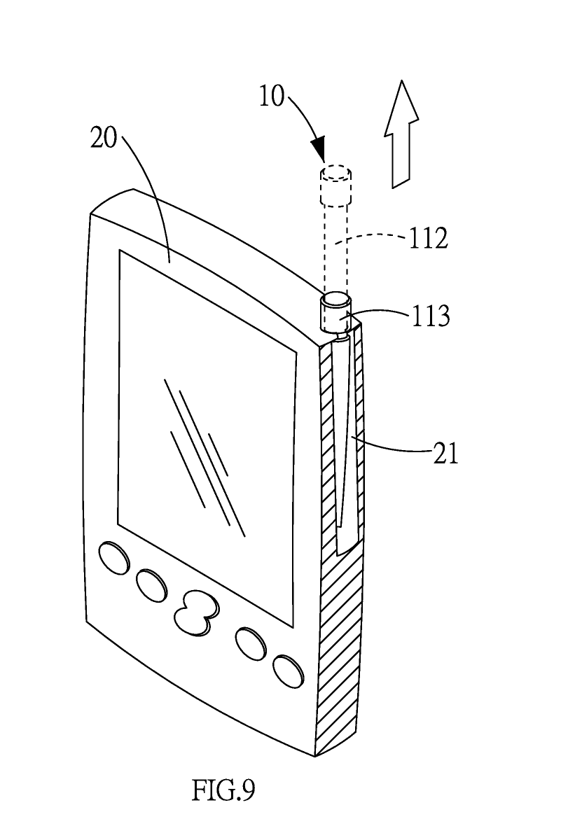

Moreover, to satisfy the convenience in carry-on and incorporate with the shape design of the capacitive touch panel 20, the invention can further be a telescopic type touch structure as shown in a fourth embodiment of FIG. 8 and FIG. 9. The hand-held portion 11 is equipped with an inner bushing 112 and an external bushing 113 that are fit to each other and that are correspondingly displaced in a radial direction. When the user holds the telescopic type touch structure to operate functions or write something, the inner bushing 112 is lengthened to allow the user to hold the structure. On the other hand, when the structure is not in use, the inner bushing 112 can be downwardly pressed to store in the external bushing 13 to reduce the length of the inner bushing 112, thereby increasing the convenience of storing and carrying.

Of course, the invention has a placing slot 21, for storing the stylus structure, adjacent to the capacitive touch panel 20. When the stylus structure 10 is not in use, the inner bushing 112 is downwardly pressed to store the external bushing 113 to directly place in the placing slot 21 of the capacitive touch panel 20 so that the length of the stylus structure 10 is reduced to incorporate with the shape requirement for the capacitive touch panel 20. Moreover, when the user needs to use the stylus structure 10, the stylus structure 10 can be drawn out from the placing slot 21, and the inner bushing 112 is pulled out of the external bushing 113 to lengthen the length of the stylus structure 10 that can be held by the user.

More specifically, the stylus structure of the invention can substitute for a conventional hand operating manner to allow the user to conveniently select required programs or files from small and tiny selection menus or to precisely touch the touch panel. Moreover, it can prevent the touch panel from being directly touched by fingers to effectively reduce dirt remaining on the touch panel, thereby maintaining a clean surface of the touch panel and improving the appearance of the touch panel. Moreover, the smoothness can be provided through the encapsulation layer of the end so that when the user performs sliding and touch operations, the touch panel can be prevented from being damaged.

The stylus structure for touch panel improves over the prior art and complies with patent application requirements, and thus is duly filed for patent application. While the invention has been described above as a device with specific embodiments, numerous modifications and variations could be made thereto by those generally skilled in the art without departing from the scope and spirit of the invention set forth in the claims.

What is claimed is:

1. A stylus structure for touch panel comprising:
a hand-held portion held by a user; and
a touch portion disposed at an end of the hand-held portion, the touch portion having a soft material body and an encapsulation layer for encapsulating the soft material body, the encapsulation layer being a conductive material.

2. The stylus structure for touch panel as recited in claim 1, wherein the hand-held portion is a conductive material.

3. The stylus structure for touch panel as recited in claim 1, wherein an end if the hand-held portion is further equipped with a pivot member, and the pivot member is connected to the touch portion.

4. The stylus structure for touch panel as recited in claim 3, wherein the pivot member is a sphere joint, and the touch portion is relatively formed with an arc junction surface.

5. The stylus structure for touch panel as recited in claim 1, wherein the hand-held portion is disposed with an inner bushing and an external bushing that are fit to each other and that are correspondingly displaced in a radial direction.

6. The stylus structure for touch panel as recited in claim 1, wherein the soft material body of the touch portion is rubber, plastic or foam.

7. The stylus structure for touch panel as recited in claim 1, wherein the encapsulation layer is disposed on the soft material body of the touch portion through carbon powder by coating manner.

8. The stylus structure for touch panel as recited in claim 1, wherein the encapsulation layer is disposed on the soft material body of the touch portion through copper powder by coating manner.

9. The stylus structure for touch panel as recited in claim 1, wherein the stylus structure is a pen structure, and the hand-held portion is a pen shaft.

10. The stylus structure for touch panel as recited in claim 1, wherein the stylus structure is a finger ring structure, and the hand-held portion is a flexible collar.

11. A stylus structure for touch panel comprising:
a hand-held portion held by a user; and
a touch portion disposed at an end of the hand-held portion, the touch portion having a soft material body and an encapsulation layer for encapsulating the soft material body, the encapsulation layer being a non-conductive material.

12. The stylus structure for touch panel as recited in claim 11, wherein the encapsulation layer is a PU (polyurethane) or a silica gel.

13. The stylus structure for touch panel as recited in claim 11, wherein the hand-held portion is a conductive material.

14. The stylus structure for touch panel as recited in claim 11, wherein an end of the hand-held portion is further equipped with a pivot member, and the pivot member is connected to the touch portion.

15. The stylus structure for touch panel as recited in claim 14, wherein the pivot member is a sphere joint, and the touch portion is relatively formed with an arc junction surface.

16. The stylus structure for touch panel as recited in claim 11, wherein the hand-held portion is disposed with an inner bushing and an external bushing that are fit to each other and that are correspondingly displaced in a radial direction.

17. The stylus structure for touch panel as recited in claim 11, wherein the soft material body of the touch portion is rubber, plastic or foam.

18. The stylus structure for touch panel as recited in claim 11, wherein the stylus structure is a pen structure, and the hand-held portion is a pen shaft.

19. The stylus structure for touch panel as recited in claim 11, wherein the stylus structure is a finger ring structure, and the hand-held portion is a flexible collar.
